(19) United States
(12) Patent Application Publication
(10) Pub. No.: US 2013/0166835 A1
(43) Pub. Date: Jun. 27, 2013

(54) ARITHMETIC PROCESSING SYSTEM AND METHOD, AND NON-TRANSITORY COMPUTER READABLE MEDIUM

(71) Applicant: Shotaro MIYAMOTO, Kanagawa (JP)

(72) Inventor: Shotaro MIYAMOTO, Kanagawa (JP)

(73) Assignee: FUJI XEROX CO., LTD., Tokyo (JP)

(21) Appl. No.: 13/596,406

(22) Filed: Aug. 28, 2012

(30) Foreign Application Priority Data
Dec. 26, 2011 (JP) 2011-282890

(51) Int. Cl. G06F 12/02

(52) U.S. Cl. 711/105; 711/170; 711/E12.002

(57) ABSTRACT

An arithmetic processing system includes the following elements. Plural storage media, which are physically independent, having storage regions are provided. Plural processors execute processing by using the storage regions of the plural storage media. An allocating unit allocates the storage regions of the plural storage media to the plural processors. A determining unit determines whether a total value of storage amounts necessary for the plural processors to execute processing is equal to or smaller than a value obtained by subtracting a storage capacity of one of the storage media from a total capacity of the plural storage media. A reallocating unit reallocates the allocated storage regions to the plural processors when the above-described determination result is positive. A discontinuing unit discontinues an operation performed by a storage medium which does not contain any of the storage regions reallocated to the plural processors as a result of reallocating the storage regions.

### CROSS-REFERENCE TO RELATED APPLICATIONS

This application is based on and claims priority under 35 USC 119 from Japanese Patent Application No. 2011-282890 filed Dec. 26, 2011.

### BACKGROUND

### Technical Field

The present invention relates to an arithmetic processing system and method, and a non-transitory computer readable medium.

### SUMMARY

According to an aspect of the invention, there is provided an arithmetic processing system including: plural storage media having storage regions, the plural storage media being physically independent; plural processors that execute processing by using the storage regions of the plural storage media; an allocating unit that allocates the storage regions of the plural storage media to the plural processors; a determining unit that determines, from a result obtained by querying the plural processors about a total value of storage amounts necessary for the plural processors to execute processing, whether the total value of the storage amounts necessary for the plural processors to execute processing is equal to or smaller than a value obtained by subtracting a storage capacity of one of the storage media from a total capacity of the plural storage media; a reallocating unit that reallocates the storage regions that have been allocated to the plural processors by using the allocating unit to the plural processors when the determining unit determines that the total value of the storage amounts necessary for the plural processors to execute processing is equal to or smaller than the value obtained by subtracting the storage capacity of one of the storage media from the total capacity of the plural storage media; and a discontinuing unit that discontinues an operation performed by a storage medium which does not contain any of the storage regions reallocated to the plural processors as a result of reallocating the storage regions by using the reallocating unit.

### BRIEF DESCRIPTION OF THE DRAWINGS

An exemplary embodiment of the present invention will be described in detail based on the following figures, wherein:

FIG. 1 illustrates an image forming system according to an exemplary embodiment of the invention;

FIG. 2 illustrates an example of the hardware configuration of an image forming apparatus according to an exemplary embodiment of the invention;

FIG. 3 is a block diagram illustrating the configuration that causes an image forming apparatus to be operated according to an exemplary embodiment of the invention;

FIG. 4 is a flowchart illustrating the overall operation performed by an image forming apparatus according to an exemplary embodiment of the invention;

FIG. 5 is a flowchart illustrating an allocation method for storage regions according to an exemplary embodiment of the invention;

FIG. 6 illustrates examples of storage regions of random access memories (DRAMs) allocated to guest operating systems (OSs) according to an exemplary embodiment of the invention;

FIG. 7 is a flowchart illustrating a determination method for a total value of maximum RAM usage amounts;

FIG. 8 illustrates an example of a management table that manages maximum RAM usage amounts of guest OSs;

FIG. 9 is a flowchart illustrating a reallocation method and a refresh operation discontinuing method;

FIG. 10 illustrates examples of storage regions of DRAMs reallocated to guest OSs when a reallocation instruction is given; and

FIG. 11 illustrates examples of storage regions of DRAMs reallocated to guest OSs when a reallocation instruction is given.

### DETAILED DESCRIPTION

An exemplary embodiment of the invention will be described below in detail with reference to the accompanying drawings.

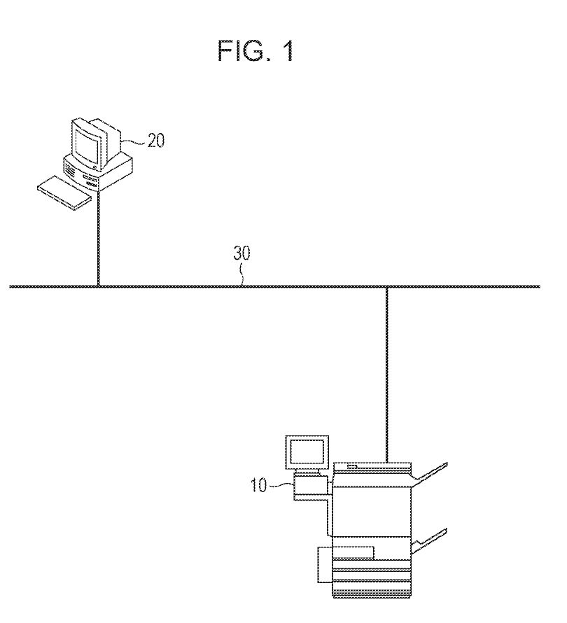

FIG. 1 illustrates an image forming system according to an exemplary embodiment of the invention. In FIG. 1, an image forming apparatus 10 is connected to a terminal apparatus 20 via a network 30. The image forming apparatus 10 prints, on paper, an image represented by image data transmitted from the terminal apparatus 20 via the network 30.

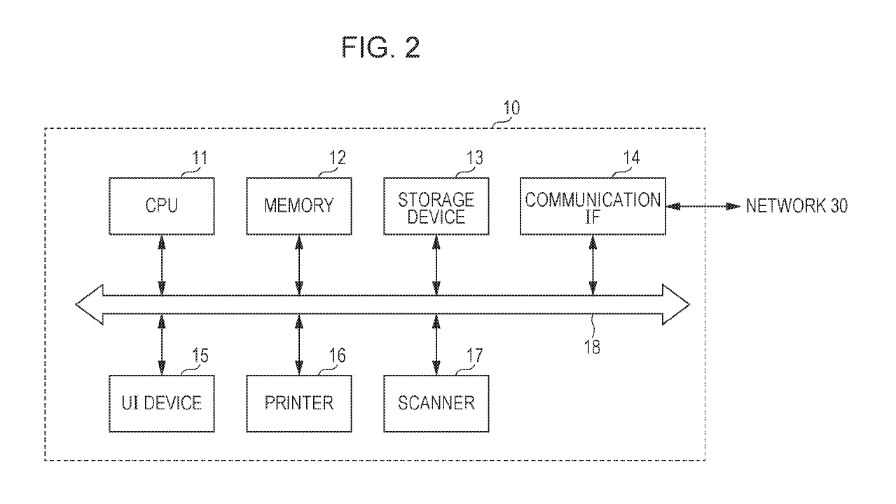

The hardware configuration of the image forming apparatus 10 according to this exemplary embodiment will be discussed in detail with reference to FIG. 2.

The image forming apparatus 10 includes, as shown in FIG. 2, a central processing unit (CPU) 11, a memory 12, a storage device 13, such as a hard disk drive (HDD), a communication interface (IF) 14, which sends and receives data to and from an external device via the network 30, a user interface (UI) device 15 including a touch panel or a liquid crystal display and a keyboard, a printer 16, and a scanner 17. These elements are connected to one another via a control bus 18.

The CPU 11 executes predetermined processing on the basis of a control program stored in the memory 12 or the storage device 13 so as to control an operation of the image forming apparatus 10. In this exemplary embodiment, a description will be given, assuming that the CPU 11 reads and executes the control program stored in the memory 12 or the storage device 13. Alternatively, the control program may be stored in a storage medium, such as a compact disc read only memory (CD-ROM), and may be provided to the CPU 11.

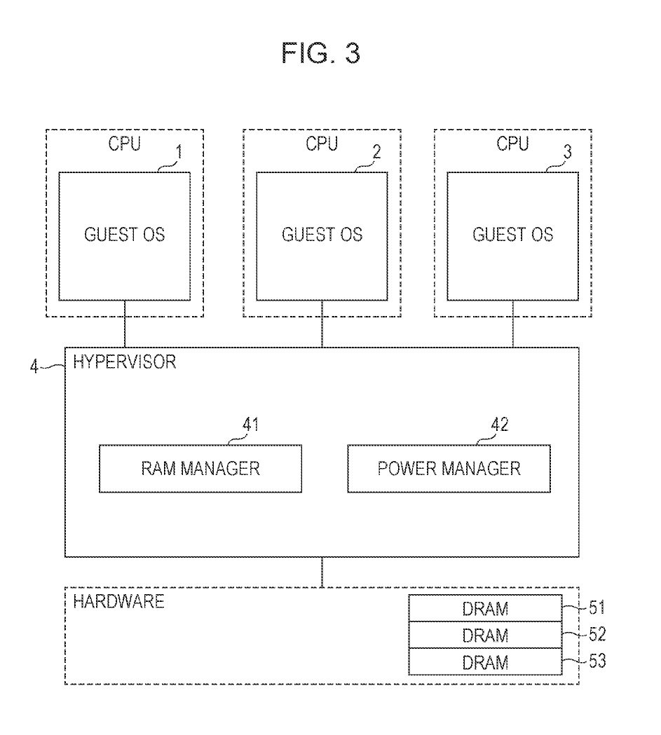

FIG. 3 is a block diagram illustrating a configuration that causes the image forming apparatus 10 to be operated as a result of executing the control program.

The image forming apparatus 10 includes, as shown in FIG. 3, plural CPUs. Guest operating systems (OSs) 1 through 3 are installed in the associated CPUs. The image forming apparatus 10 is operated by the guest OSs 1 through 3, a hypervisor 4 that manages the guest OSs 1 through 3, and dynamic random access memories (DRAMs) 51 through 53. The hypervisor 4 functions as a RAM manager 41 and a power manager 42.

In the image forming apparatus 10, the DRAMs 51 through 53, which are physically independent plural storage media, are stored in hardware. In this exemplary embodiment, storage regions of the DRAM 51 are located at addresses 0x00000000 through 0x3FFFFFFF, storage regions of the DRAM 52 are located at addresses 0x40000000 through 0x7FFFFFFF, and storage region of the DRAM 53 are located at addresses 0x80000000 through 0xBFFFFFFF. The DRAMs 51 through 53 each have a memory (storage region) capacity of one gigabyte (GB).

The guest OSs 1 through 3 are basic software that manages the system of the image forming apparatus 10. The guest OSs 1 through 3 are executed by the respective CPUs and execute processing by using the storage regions of the DRAMs 51 through 53.

The hypervisor 4 allocates the storage regions of the DRAMs 51 through 53 to the guest OSs 1 through 3. The hypervisor 4 also controls the starting of the guest OSs 1 through 3.

After allocating the storage regions of the DRAMS 51 through 53 to the guest OSs 1 through 3 by using the hypervisor 4, the RAM manager 41 queries the guest OSs 1 through 3 about a total value of storage amounts necessary for the guest OSs 1 through 3 to execute processing, and obtains responses from the guest OSs 1 through 3. The RAM manager 41 then determines from the obtained responses whether the total value of the storage amounts necessary for the guest OSs 1 through 3 to execute processing is equal to or smaller than a value subtracting the memory capacity of one DRAM from the total capacity of the DRAMs 51 through 53. More specifically, the total value of the storage amounts necessary for the guest OSs 1 through 3 to execute processing is a value obtained by multiplying the maximum storage amount of RAMs used by the guest OSs 1 through 3, which is a maximum storage amount of RAMs used for processing executed by the guest OSs 1 through 3, (hereinafter such a maximum amount will be referred to as a “maximum RAM usage amount”) by a margin factor (1.5). In this exemplary embodiment, the memory capacity of each of the DRAMs 51 through 53 is one GB, and thus, the total capacity of the DRAMs 51 through 53 is three GB. Accordingly, the RAM manager 41 determines whether the value obtained by multiplying the maximum RAM usage amount of the guest OSs 1 through 3 by the margin factor is equal to or smaller than a value (two GB) obtained by subtracting one GB, which is the memory capacity of one of the DRAMs 51 through 53, from the total capacity of the guest OSs 1 through 3 (three GB). The margin factor is a magnification factor for determining the memory capacity that can secure the maximum RAM usage amount of the guest OSs 1 through 3.

If the RAM manager 41 determines from the obtained responses that the total value of the storage amounts necessary for the guest OSs 1 through 3 to execute processing is equal to or smaller than a value subtracting the memory capacity of one of the DRAMs 51 through 53 from the total capacity of the DRAMs 51 through 53, the power manager 42 performs the following operation. That is, the power manager 42 reallocates storage regions that can secure the maximum RAM usage amount of the guest OSs 1 through 3 to the guest OSs 1 through 3 such that the storage regions are continuously arranged in the DRAMs 51 through 53. The power manager 42 also discontinues a refresh operation performed by a DRAM which does not contain any of the storage regions reallocated to the guest OSs 1 through 3. More specifically, in this exemplary embodiment, if it is determined that the value obtained by multiplying the maximum RAM usage amount of the guest OSs 1 through 3 by the margin factor is equal to or smaller than two GB, the power manager 42 reallocates storage regions having a memory capacity equal to the value obtained by multiplying the maximum RAM usage amount of the guest OSs 1 through 3 by the margin factor to the guest OSs 1 through 3 such that the storage regions are continuously arranged in the DRAMs 51 through 53. Then, the power manager 42 discontinues a refresh operation performed by an unused DRAM which does not contain any of the storage regions reallocated to the guest OSs 1 through 3.

A detailed description will now be given, with reference to the drawings, of the operation performed by the image forming apparatus 10 of this exemplary embodiment.

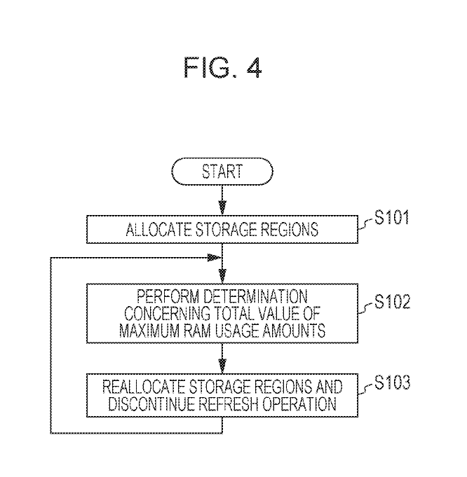

The overall operation performed by the image forming apparatus 10 will first be discussed with reference to FIG. 4.

In step S101, upon starting of the image forming apparatus 10, the hypervisor 4 allocates the storage regions of the DRAMs 51 through 53 to the guest OSs 1 through 3. A specific allocation method will be discussed later.

Then, in step S102, the RAM manager 41 determines whether the value obtained by multiplying the maximum RAM usage amounts of the guest OSs 1 through 3 by the margin factor (1.5) is equal to or smaller than two GB. A specific determination method in step S102 will be discussed later.

Then, if the RAM manager 41 determines that the above-described value is equal to or smaller than two GB, in step S103, the power manager 42 reallocates storage regions of the DRAMs 51 through 53 to the guest OSs 1 through 3 such that the storage regions reallocated to the guest OSs 1 through 3 are continuously arranged. The power manager 42 also discontinues a refresh operation performed by an unused RAM from among the RAMs 51 through 53. A specific reallocation method and refresh operation discontinuing method will also be discussed later.

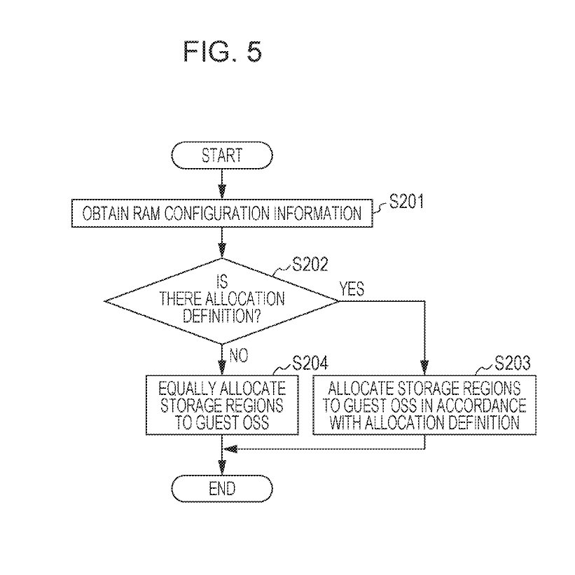

The specific method for allocating the storage regions of the DRAMs 51 through 53 to the guest OSs 1 through 3 in step S101 will be discussed in detail with reference to the flowchart of FIG. 5.

Upon starting of the image forming apparatus 10, in step S201, the hypervisor 4 queries the DRAMs 51 through 53 about the RAM configuration, and then obtains information concerning the RAM configuration, such as the memory capacity and the number of DRAMs. In step S201, the hypervisor 4 obtains information that physically independent three DRAMs, i.e., the DRAMs 51 through 53, are disposed and that the memory capacity of each of the DRAMs 51 through 53 is one GB.

Then, in step S202, the hypervisor 4 determines whether there is any definition for allocation of storage regions (hereinafter referred to as “memory allocation definition”) to the guest OSs 1 through 3. In the memory allocation definition, predetermined storage amounts to be allocated to the guest OSs 1 through 3 are defined, e.g., a storage amount of 0.5 GB is allocated to the guest OS 1, a storage amount of1.5 GB is allocated to the guest OS 2, and a storage amount of one GB is allocated to the guest OS 3.

If it is determined in step S202 that there is no memory allocation definition, the process proceeds to step S204. In step S204, the hypervisor 4 equally allocates the storage regions of the DRAMs 51 through 53 to the guest OSs 1 through 3 so that the guest OSs 1 through 3 can equally utilize the allocated storage regions. In this exemplary embodiment, if there is no memory allocation definition, on the basis of the information indicating that the DRAMs 51 through 53 each has a capacity of one GB obtained in step S201, the hypervisor 4 equally allocates a storage region having one GB to each of the guest OSs 1 through 3. For example, the storage region of the DRAM 51 is allocated to the guest OS 1, the storage region of the DRAM 52 is allocated to the guest OS 2, and the storage region of the DRAM 53 is allocated to the guest OS 3.

If it is determined in step S202 that there is a memory allocation definition, the process proceeds to step S203. In step S203, the hypervisor 4 allocates the storage regions of the DRAMs 51 through 53 to the guest OSs 1 through 3 in accordance with the memory allocation definition.

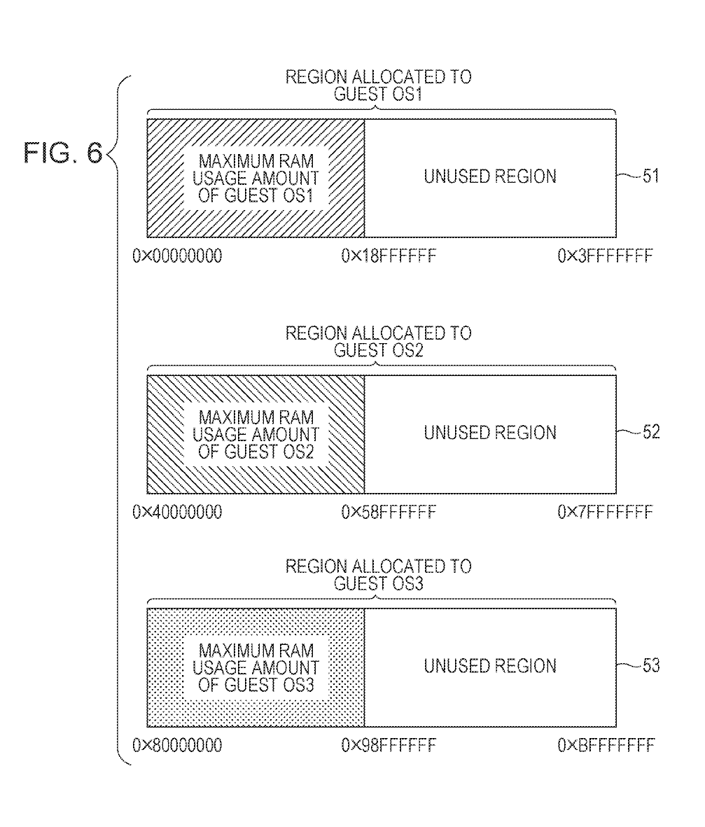

A description will now be given of a case in which there is no memory allocation definition and the storage regions of the DRAMs 51 through 53 (each having a size of one GB) are equally allocated to the guest OSs 1 through 3, respectively, as shown in FIG. 6.

In FIG. 6, a storage region from the address 0x00000000 to the address 0x3FFFFFFF, which is the storage region of the DRAM 51, is allocated to the guest OS 1. A storage region from the address 0x40000000 to the address 0x7FFFFFFF, which is the storage region of the DRAM 52, is allocated to the guest OS 2. A storage region from the address 0x80000000 to the address 0xBFFFFFFF, which is the storage region of the DRAM 53, is allocated to the guest OS 3. In practice, however, a storage region from the address 0x00000000 to the address 0x18FFFFFF (400 megabytes (MB)) is used by the guest OS 1 as the maximum RAM usage amount. The storage region from the address 0x40000000 to the address 0x58FFFFFF (400 megabytes (MB)) is used by the guest OS 2 as the maximum RAM usage amount. The storage region from the address 0x80000000 to the address 0x98FFFFFF (400 megabytes (MB)) is used by the guest OS 3 as the maximum RAM usage amount.

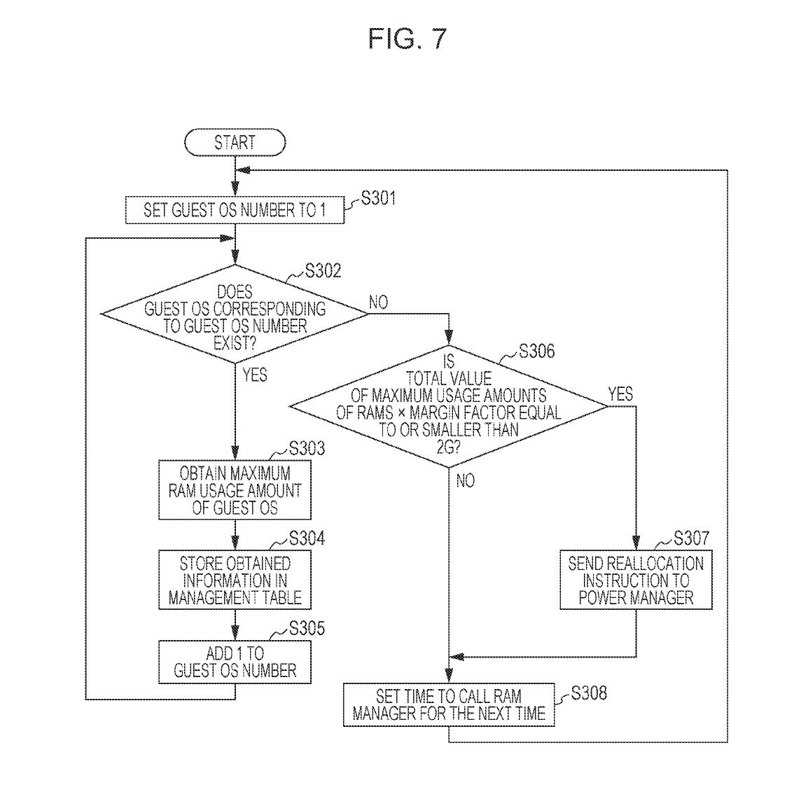

A method for performing determination concerning the total maximum RAM usage amount in step S102 will be discussed in detail with reference to the flowchart of FIG. 7.

In step SS01, the RAM manager 41 sets the guest OS number to 1.

Then, in step S302, the RAM manager 41 determines whether a guest OS corresponding to the guest OS number exists. In this exemplary embodiment, the guest OSs 1 through 3 are provided. Accordingly, if the guest OS number is equal to or smaller than three, the result of step S302 is YES, and if the guest OS number is equal to or greater than four, the result of step S302 is NO.

If a guest OS corresponding to the guest OS number exists (the result of step S302 is YES), the process proceeds to step S303. In step S303, the RAM manager 41 queries the guest OS about the maximum RAM usage amount of the guest OS, and obtains information concerning the maximum RAM usage amount, such as that shown in FIG. 6. For example, if the guest OS number is 1, the RAM manager 41 obtains information indicating that the maximum RAM usage amount of the guest OS 1 is 400 MB.

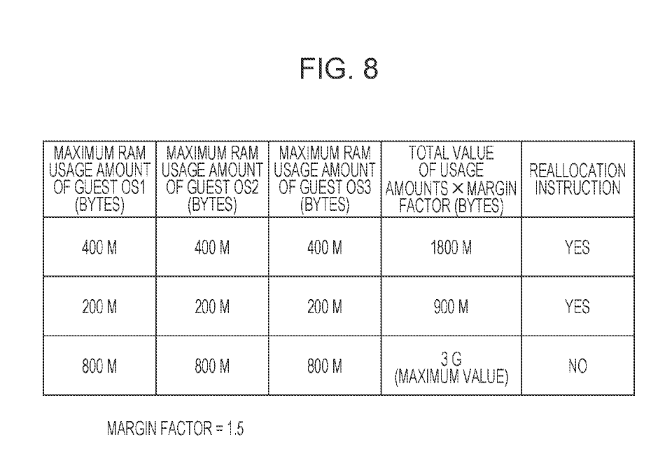

Then, in step S304, the RAM manager 41 stores the information obtained in step S303 in a management table, such as that shown in FIG. 8.

Then, in step S305, the RAM manager 41 adds one to the guest OS number and returns to step S302. In this manner, steps S302 through S305 are repeated, and the maximum RAM usage amounts of the guest OSs 1 through 3 are stored in the management table.

Then, after the maximum RAM usage amounts of the guest OSs 1 through 3 are stored in the management table, the guest OS number becomes 4, and there is no guest OS corresponding to the guest OS number. Accordingly, the result of step S302 is NO, and the process proceeds to step S306. In step S306, the RAM manager 41 determines by referring to the management table whether the total value obtained by multiplying the maximum RAM usage amounts of the guest OSs 1 through 3 by the margin factor (1.5) is equal to or smaller than 2 GB.

If the result of step S306 is YES, the process proceeds to step S307. In step S307, the RAM manager 41 sends an instruction to perform reallocation to the power manager 42.

For example, if the maximum RAM usage amount of each of the guest OSs 1 through 3 is 400 MB, as shown in FIG. 8, the total value obtained by multiplying the maximum RAM usage amounts of the guest OSs 1 through 3 by the margin factor is 1800 MB. Thus, the total value is smaller than 2 GB (the result of step S306 is YES), and the RAM manager 41 sends an instruction to perform reallocation to the power manager 307. If the maximum RAM usage amount of each of the guest OSs 1 through 3 is 200 MB, as shown in FIG. 8, the total value obtained by multiplying the maximum RAM usage amounts of the guest OSs 1 through 3 by the margin factor is 900 MB. Thus, the total value is smaller than 2 GB (the result of step S306 is YES), and the RAM manager 41 sends an instruction to perform reallocation to the power manager 307.

In contrast, if the maximum RAM usage amount of each of the guest OSs 1 through 3 is 800 MB, as shown in FIG. 8, the total value obtained by multiplying the maximum RAM usage amounts of the guest OSs 1 through 3 by the margin factor is 3 GB. Thus, the total value is larger than 2 GB (the result of step S306 is NO), and the RAM manager 41 does not send an instruction to perform reallocation to the power manager 307.

If the result of step S306 is NO, or after step S307, the process proceeds to step S308. In step S308, the time to call the RAM manager 41 for the next time is set. The process then returns to step S301. In this case, the time to call the RAM manager 41 for the next time may be set by a user or may be set in the RAM manager 41 in advance.

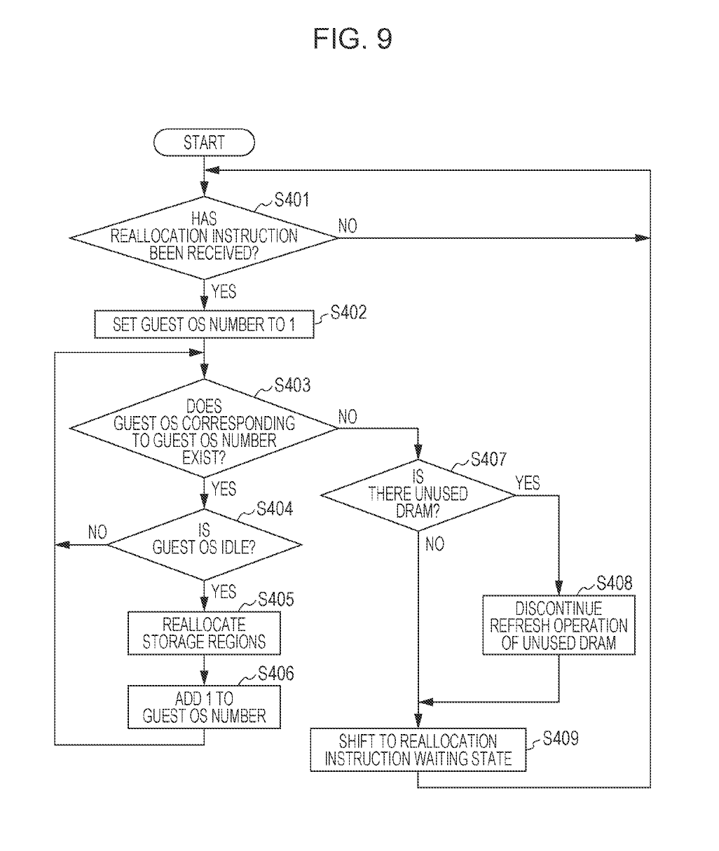

A reallocation method and a refresh operation discontinuing method in step S103 will be discussed below in detail with reference to the flowchart of FIG. 9.

In step S401, the power manager 42 is in the standby state in which it waits for a reallocation instruction, and determines whether a reallocation instruction has been received from the RAM manager 41. If it is determined in step S401 that a reallocation instruction has not been received from the RAM manager 41 (the result of step S401 is NO), the power manager 42 maintains a loop state in which it waits for a reallocation instruction from the RAM manager 41.

If it is determined in step S401 that a reallocation instruction has been received from the RAM manager 41 (the result of step S401 is YES), the process proceeds to step S402. In step S402, the power manager 42 cancels the loop state in step S401 and sets the guest OS number to 1. Then, the power manager 42 determines in step S403 whether a guest OS corresponding to the guest OS number exists.

If it is determined in step S403 that a guest OS corresponding to the guest OS number exists (the result of step S403 is YES), the power manager 41 determines in step S404 whether the guest OS corresponding to the guest OS number is idle. If it is determined in step S404 that the guest OS is not idle (the result of step S404 is NO), the process returns to step S403.

In contrast, if it is determined in step S404 that the guest OS is idle (the result of step S404 is YES), the process proceeds to step S405. In step S405, the power manager 42 shuts down the guest OS and then restarts it. When restarting the guest OS, the power manager 42 reallocates a storage region that can secure the maximum RAM usage amount of the guest OS to the guest OS.

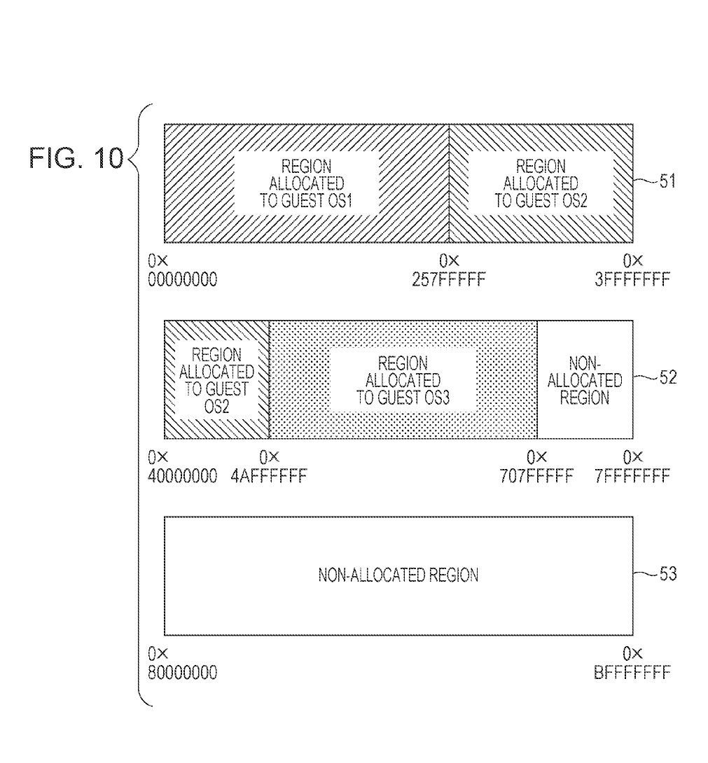

A case in which the maximum RAM usage amount of each of the guest OSs 1 through 3 is 400 MB and a reallocation instruction has been given to the power manager 42 in step S307 will be discussed with reference to FIG. 10.

When the guest OS number is 1, as shown in FIG. 10, the power manager 42 reallocates a storage region (from the address 0x00000000 to the address 0x257FFFFF) having a size of 600 MB, which is a value obtained by multiplying the maximum RAM usage amount by the margin factor, to the guest OS 1. Then, when the guest OS number is 2, as shown in FIG. 10, the power manager 42 reallocates a storage region (from the address 0x25800000, which immediately follows the final address 0x257FFFFF of the storage region allocated to the guest OS 1, to the address 0x4AFFFFFF) having a size of 600 MB, which is a value obtained by multiplying the maximum RAM usage amount by the margin factor, to the guest OS 2. Then, when the guest OS number is 3, as shown in FIG. 10, the power manager 42 reallocates a storage region (starting from the address 0x4B000000, which immediately follows the final address 0x4AFFFFFF of the storage region allocated to the guest OS 2, to the address 0x707FFFFF) having a size of 600 MB, which is a value obtained by multiplying the maximum RAM usage amount by the margin factor, to the guest OS 3. In this manner, the power manager 42 performs reallocation such that the storage regions allocated to the guest OSs 1 through 3 are continuously arranged.

Then, in step S406, the power manager 42 adds one to the guest OS number and returns to step S403.

If it is determined in step S403 that a guest OS corresponding to the guest OS number does not exist (the result of step S403 is NO), the process proceeds to step S407. In step S407, the power manager 42 determines whether there is any unused DRAM, among the DRAMs 51 through 53, which is constituted of only a non-allocated region and does not have any of the storage regions allocated to the guest OSs 1 through 3.

If there is an unused DRAM (the result of step S407 is YES), the process proceeds to step S408. In step S408, the power manager 42 sends a signal indicating an instruction to discontinue a refresh operation performed by the unused DRAM, and upon receiving the signal from the power manager 42, the DRAM discontinues a refresh operation.

Then, as a result of reallocating storage regions to the guest OSs 1 through 3 by executing steps S405 and S406, as shown in FIG. 10, the entire storage region of the DRAM 53 is released as a non-allocated region, which is not allocated to any of the guest OSs 1 through 3, and the power manager 42 determines that the DRAM 53 is an unused DRAM. Then, the power manager 42 sends a signal indicating an instruction to discontinue a refresh operation to the DRAM 53, and the DRAM 53 discontinues a refresh operation.

If there is no unused DRAM (the result of step S407 is NO), or after step S408, the process proceeds to step S409. In step S409, the power manager 42 enters the standby state in which it waits for a reallocation instruction from the RAM manager 41.

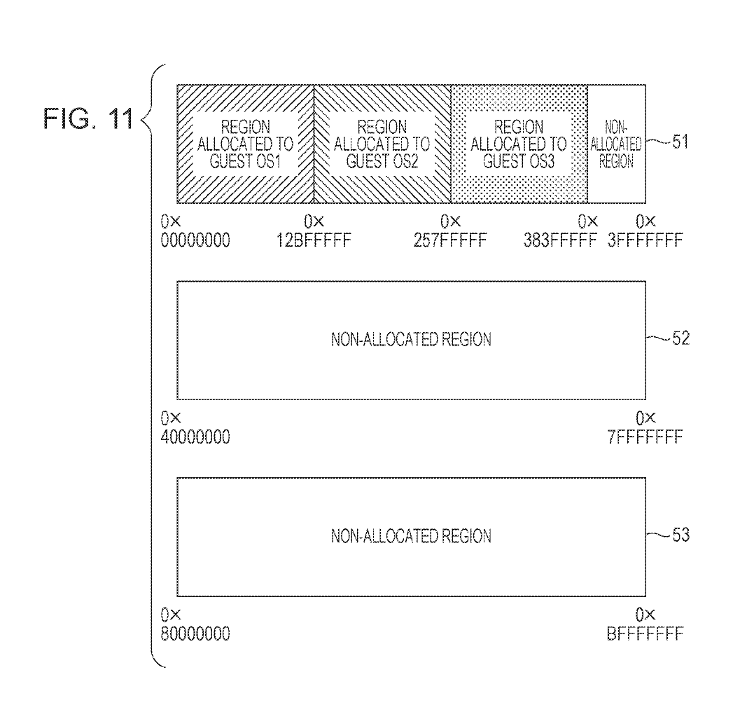

A case in which the maximum RAM usage amount of each of the guest OSs 1 through 3 is 200 MB and a reallocation instruction has been given to the power manager 42 will be discussed with reference to FIG. 11. When the guest OS number is 1, as shown in FIG. 11, in step S405, the power manager 42 reallocates a storage region (from the address 0x00000000 to the address 0x12BFFFFF) having a size of 300 MB, which is a value obtained by multiplying the maximum RAM usage amount by the margin factor, to the guest OS 1. Then, when the guest OS number is 2, as shown in FIG. 11, the power manager 42 reallocates a storage region (from the address 0x12C00000, which immediately follows the final address 0x12BFFFFF of the storage region allocated to the guest OS 1, to the address 0x257FFFFF) having a size of 300 MB, which is a value obtained by multiplying the maximum RAM usage amount by the margin factor, to the guest OS 2. Then, when the guest OS number is 3, as shown in FIG. 11, the power manager 42 reallocates a storage region (from the address 0x25800000, which immediately follows the final address 0x257FFFFF of the storage region allocated to the guest OS 2, to the address 0x383FFFFF) having a size of 300 MB, which is a value obtained by multiplying the maximum RAM usage amount by the margin factor, to the guest OS 3.

Then, as shown in FIG. 11, all the storage regions of the DRAMs 52 and 53 are released as non-allocated regions. Then, in step S407, the power manager 42 determines that the DRAMs 52 and 53 are unused DRAMs. In step S408, the power manager 42 then sends a signal indicating an instruction to discontinue a refresh operation to the DRAMs 52 and 53.

As described above, in this exemplary embodiment, storage regions are reallocated to the guest OSs 1 through 3 such that storage regions that can secure the maximum RAM usage amounts of the guest OSs 1 through 3 are continuously arranged in the DRAMs. With this reallocation operation, in this exemplary embodiment, a non-allocated region, which is not allocated to any of the guest OSs, may be generated, and if there is an unused DRAM which is constituted of only non-allocated regions, the power manager 42 discontinues a refresh operation performed by this unused DRAM. It is thus possible to reduce power consumption by an amount which would otherwise be consumed by a refresh operation performed by the unused DRAM.

In a DRAM, a refresh operation is periodically performed so as to continuously charge a capacitor. Accordingly, power consumed in a DRAM is largely due to a refresh operation, and by discontinuing this refresh operation, power consumption is considerably reduced.

In this exemplary embodiment, when reallocating storage regions to the guest OSs 1 through 3, storage regions are reallocated such that storage regions that can secure the maximum RAM usage amounts of the guest OSs 1 through 3 are continuously arranged in the DRAMs. However, an exemplary embodiment of the invention may be modified as follows. Storage regions may be reallocated such that storage regions that can secure the maximum RAM usage amounts of the guest OSs 1 through 3 are discontinuously arranged in the DRAMs. In this case, too, an unused DRAM may be generated.

Additionally, in this exemplary embodiment, the RAM manager 41 obtains information concerning the maximum RAM usage amounts of the guest OSs 1 through 3. However, information obtained by the RAM manager 41 is not restricted to maximum RAM usage amounts.

In this exemplary embodiment, three DRAMs are used. However, the number of DRAMs is not restricted to three, and two DRAMs or four or more DRAMs may be used.

In this exemplary embodiment, the plural DRAMs each have a memory capacity of one GB. However, the memory capacity amounts of plural DRAMs may be different. In this case, too, the RAM manager 41 may determine whether the total value of the maximum RAM usage amounts of the guest OSs 1 through 3 is equal to or smaller than a value obtained by subtracting the memory capacity of one of the DRAMs from the total capacity of the DRAMs. Then, the power manager 42 may reallocate storage regions to the guest OSs 1 through 3 and may discontinue a refresh operation performed by an unused DRAM. Additionally, the memory capacity of each DRAM is not restricted to one GB, and may be a larger capacity, such as three GB, or a smaller capacity, such as 200 MB.

In this exemplary embodiment, the refresh operation performed by an unused DRAM is discontinued. Alternatively, if power supply to a DRAM can be safely interrupted, power supply to an unused DRAM may be interrupted.

In this exemplary embodiment, DRAMs are used, and thus, a refresh operation performed by an unused DRAM is discontinued. However, any type of storage medium may be used. For example, static random access memories (SRAMs) may be used, in which case, the operation of an unused SRAM may be stopped by interrupting power supply to the unused SRAM.

In this exemplary embodiment, an image forming system including the image forming apparatus 10 has been discussed. However, a computer system, such as a personal computer, including plural storage media and plural processors that perform processing by using plural regions of the plural storage media, may be implemented as an embodiment of the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An arithmetic processing system comprising:
a plurality of storage media having storage regions, the plurality of storage media being physically independent;
a plurality of processors that execute processing by using the storage regions of the plurality of storage media;
an allocating unit that allocates the storage regions of the plurality of storage media to the plurality of processors;
a determining unit that determines, from a result obtained by querying the plurality of processors about a total value of storage amounts necessary for the plurality of processors to execute processing, whether the total value of the storage amounts necessary for the plurality of processors to execute processing is equal to or smaller than a value obtained by subtracting a storage capacity of one of the storage media from a total capacity of the plurality of storage media;
a reallocating unit that reallocates the storage regions that have been allocated to the plurality of processors by using the allocating unit to the plurality of processors when the determining unit determines that the total value of the storage amounts necessary for the plurality of processors to execute processing is equal to or smaller than the value obtained by subtracting the storage capacity of one of the storage media from the total capacity of the plurality of storage media; and
a discontinuing unit that discontinues an operation performed by a storage medium which does not contain any of the storage regions reallocated to the plurality of processors as a result of reallocating the storage regions by using the reallocating unit.

2. The arithmetic processing system according to claim 1, wherein, when the determining unit determines that the total value of the storage amounts necessary for the plurality of processors to execute processing is equal to or smaller than the value obtained by subtracting the storage capacity of one of the storage media from the total capacity of the plurality of storage media, the reallocating unit reallocates storage regions which secure the storage amounts necessary for the plurality of processors to execute processing to the plurality of processors such that the reallocated storage regions are continuously arranged in the plurality of storage media.

3. The arithmetic processing system according to claim 1, wherein, after allocating the storage regions of the plurality of storage media to the plurality of processors by using the allocating unit, the determining unit queries the plurality of processors about the total value of the storage amounts necessary for the plurality of processors to execute processing.

4. The arithmetic processing system according to claim 2, wherein, after allocating the storage regions of the plurality of storage media to the plurality of processors by using the allocating unit, the determining unit queries the plurality of processors about the total value of the storage amounts necessary for the plurality of processors to execute processing.

5. The arithmetic processing system according to claim 1, wherein:
the plurality of storage media are dynamic random access memories; and
the discontinuing unit discontinues a refresh operation performed by a storage medium which does not contain any of the storage regions reallocated to the plurality of processors from among the plurality of storage media.

6. The arithmetic processing system according to claim 2, wherein:
the plurality of storage media are dynamic random access memories; and
the discontinuing unit discontinues a refresh operation performed by a storage medium which does not contain any of the storage regions reallocated to the plurality of processors from among the plurality of storage media.

7. The arithmetic processing system according to claim 3, wherein:
the plurality of storage media are dynamic random access memories; and
the discontinuing unit discontinues a refresh operation performed by a storage medium which does not contain any of the storage regions reallocated to the plurality of processors from among the plurality of storage media.

8. The arithmetic processing system according to claim 4, wherein:
the plurality of storage media are dynamic random access memories; and
the discontinuing unit discontinues a refresh operation performed by a storage medium which does not contain any of the storage regions reallocated to the plurality of processors from among the plurality of storage media.

9. The arithmetic processing system according to claim 1, wherein the plurality of processors each execute processing on the basis of basic software that manages a computer system.

10. The arithmetic processing system according to claim 2, wherein the plurality of processors each execute processing on the basis of basic software that manages a computer system.

11. The arithmetic processing system according to claim 3, wherein the plurality of processors each execute processing on the basis of basic software that manages a computer system.

12. The arithmetic processing system according to claim 4, wherein the plurality of processors each execute processing on the basis of basic software that manages a computer system.

13. The arithmetic processing system according to claim 5, wherein the plurality of processors each execute processing on the basis of basic software that manages a computer system.

14. The arithmetic processing system according to claim 6, wherein the plurality of processors each execute processing on the basis of basic software that manages a computer system.

15. The arithmetic processing system according to claim 7, wherein the plurality of processors each execute processing on the basis of basic software that manages a computer system.

16. The arithmetic processing system according to claim 8, wherein the plurality of processors each execute processing on the basis of basic software that manages a computer system.

17. An arithmetic processing method comprising:
allocating storage regions of a plurality of storage media, which are physically independent, to a plurality of processors that execute processing by using the storage regions of the plurality of storage media;
determining, from a result obtained by querying the plurality of processors about a total value of storage amounts necessary for the plurality of processors to execute processing, whether the total value of the storage amounts necessary for the plurality of processors to execute processing is equal to or smaller than a value obtained by subtracting a storage capacity of one of the storage media from a total capacity of the plurality of storage media;
reallocating the allocated storage regions to the plurality of processors when it is determined that the total value of the storage amounts necessary for the plurality of processors to execute processing is equal to or smaller than the value obtained by subtracting the storage capacity of one of the storage media from the total capacity of the plurality of storage media; and
discontinuing an operation performed by a storage medium which does not contain any of the storage regions reallocated to the plurality of processors as a result of reallocating the storage regions.

18. A non-transitory computer readable medium storing a program causing a computer to execute a process, the computer including a plurality of processors that execute processing by using storage regions of a plurality of storage media, which are physically independent, the process comprising:
allocating the storage regions of the plurality of storage media to the plurality of processors;
determining, from a result obtained by querying the plurality of processors about a total value of storage amounts necessary for the plurality of processors to execute processing, whether the total value of the storage amounts necessary for the plurality of processors to execute processing is equal to or smaller than a value obtained by subtracting a storage capacity of one of the storage media from a total capacity of the plurality of storage media;
reallocating the allocated storage regions to the plurality of processors when it is determined that the total value of the storage amounts necessary for the plurality of processors to execute processing is equal to or smaller than the value obtained by subtracting the storage capacity of one of the storage media from the total capacity of the plurality of storage media; and
discontinuing an operation performed by a storage medium which does not contain any of the storage regions reallocated to the plurality of processors as a result of reallocating the storage regions.
